(19) United States
(12) Patent Application Publication
(10) Pub. No.: US 2002/0145284 A1
(43) Pub. Date: Oct. 10, 2002

(54) Fitting assembly for corrugated tubing

(76) Inventor: Richard N. Powell, Pine City, NY (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/828,753

(22) Filed: Apr. 9, 2001

(51) Int. Cl. F16L 17/00

(52) U.S. Cl. 285/353

(57) ABSTRACT

A fitting body seals with a free end of corrugated tubing. The fitting body has an inside opening that tapers inwardly up to the shoulder. A clamping member threads onto the fitting body and engages axially against a split ring that engages between corrugations of the tubing. The fitting body, clamping element and split ring are supplied preassembled. The split ring has an outer diameter that fits in the wider tapering part of the body and an inner diameter that receives the tubing. The tubing is inserted through the clamping member and the split ring and bottoms out against the fitting body. The clamping element is tightened on the fitting body, pulling the split ring axially while cinching it inwardly against the inward taper. This compresses the free end of the tubing against the axial abutment shoulder and achieves a seal.

### BACKGROUND OF THE INVENTION

1. Field of the Invention

The invention relates a fitting for coupling with a flexible tube that is corrugated, at least on the outside, such as corrugated stainless steel tubing. The fitting can be used between lengths of such tubing or to terminate a length or as an adapter with another coupling structure such as a male or female threaded coupling.

2. Prior Art

Fittings and structures for sealingly terminating corrugated tubing involve challenges that are somewhat different than those encountered with smooth surface cylindrical tubing. The corrugations represent a difference in diameter between spaced peaks and valleys. The diameter of a cut end of the tubing might be anywhere between the maximum and minimum. Usually such tubing is cut at a valley because the cutting tool rests easily there.

Corrugated stainless steel tubing typically has parallel annular peaks and valleys that are perpendicular to the longitudinal axis of the tubing. The difference in diameter complicates the structure needed to terminate the tubing in manner that sealingly joins the lumen or inside of the tubing with a flowpath in a fitting, as necessary to carry a gas or liquid without leakage or contamination. In order to hold the tubing and to seal against a cut end of the tubing, it is necessary to accommodate the corrugations.

A termination or fitting could be made after re-forming the corrugated tubing for a distance adjacent to a cut end, so as to complement a structure against which the tubing is to be clamped or sealed. For example, the tubing could be rolled out to a cylindrical tube shape having a diameter equal to the maximum diameter of the corrugations, or swaged inwardly to the minimum diameter, or formed to a cylindrical shape somewhere in between. Alternatively the cut end can be conically formed, e.g., flared outwardly or inwardly, with the resulting inwardly conical shape or outwardly conical flare or bell shape being clamped against a corresponding structure. This typically is a precision operation requiring tools and jigs that are not preferred. Therefore, efforts have been made to provide fittings that engage with annular corrugations on the tubing (or sometimes helical ones) in a manner that achieves a gas tight seal.

Properly engaging with corrugations to achieve a dependable seal is also a precision operation. A number of alternative fittings have been proposed in which corrugated tubing sealingly attaches to a terminal fitting that has threads or the like for making connections to some other conduit or member of a more standardized and typically not corrugated nature. For mechanically engaging with the tubing while sealing the fitting to the tubing, which is flexible, certain annular corrugations of the tubing are compressed during assembly of the fitting and become clamped between metal faces (or possibly against a washer), or alternatively certain parts of the corrugations can become flared and clamped. Compressible washers or O-rings may be mounted so as to become compressed against an axial face of a corrugation ridge or radially into a valley between ridges during assembly.

Such fittings are intended to achieve mechanical engagement and/or to make sealing contact, because relative movement of certain attachable elements during fitting assembly bring about required positioning and force relationships between the parts. Operational effectiveness is based on various assumptions that particular corrugation ridges will be located at known nominal positions at predetermined phases in the assembly process, or that the fittings parts will be assembled with the corrugated tubing in a certain way, or that the assembler will exert a predetermined precise torque on threaded parts, etc.

In U.S. Pat. No. 4,630,850—Saka, a fitting is provided with several relatively movable parts that are respectively intended to engage with or position or seal against the cut end of a corrugated tube. This arrangement is intended automatically to form a gas and fluid tight seal in a mechanical way, namely simply by assembling several parts and then tightening the fitting on a squarely cut off end of the corrugated tube. The fitting comprises a joint body having a cup shaped end that receives the corrugated tubing. The tubing fits into a hollow inside of the cup shaped end, with some radial clearance for a support member that positions the tubing in the cup shaped end. The cup shaped end of the fitting is threaded on the outside to receive a cap nut.

The support member comprises two semi circular sleeve halves that are provided with inwardly ridged shapes that complement the outward corrugations on the tubing. In one embodiment the two half sleeves form grips with ridged radially inward-facing shapes that complement the outer surfaces of five adjacent corrugations (ridges and valleys) at the end of the corrugated tubing. In another embodiment the gripping sleeve halves only engage in the ridge of one corrugation. When assembling the fitting, the gripping sleeve halves are placed on the outside of the tubing. According to the instructions, a predetermined number of corrugations are left protruding axially beyond the five or so corrugations that are engaged by the gripping sleeve halves. Specifically, three annular peaks are left protruding beyond the gripping sleeve halves. The gripping sleeve halves and the engaged corrugated tubing are assembled between a threaded body and a cap nut that both have axial facing abutments. Tightening the cap nut on the body forces the gripping sleeves axially against the body and crimps the protruding corrugation ridges between the axial abutment of the body and the axial facing end of the gripping sleeve halves. This achieves a gasketed seal between the tubing and the fitting body for an annular corrugated tubing. Similar arrangements are possible with other sorts of tubing, such as helically corrugated tubing.

For annular corrugated tubing, an 0-ring can be set into the valley between corrugation ridges and caused to seal radially between the outside of the tubing and the inside of the fitting body or cap nut. Such an O-ring is used, alone or in combination with metal rings that position or confine the O-ring, in U.S. Pat. Nos. 5,845,946; 5,857,716; and 6,102,445, all to Thomas.

Another form of seal employs a metal ring instead of an O-ring to reside in a valley between corrugation ridges and to assist in making a seal, as in U.S. Pat. No. 5,799,989—Albino. The metal ring is shaped to compress the last corrugation on a annular corrugated tube, against a male conical surface on the outside of a nose that extends from the fitting body. The cap nut has a complementary female conical surface that exerts force on the opposite side of the metal ring.

The foregoing sealed fittings are advantageous because if the assembler starts with a square cut end of tubing, and assembles and tightens the parts exactly according to plan, the result is a fitting in which the tubing is mechanically engaged and the seal does not leak. However the devices rely on fitting precision and correct assembly steps in putting together several loose parts at the required positions and tightening the cap nut appropriately on the fitting body.

For example, in Saka, the gripping sleeve halves are not pressed radially inwardly against the tubing by the fitting body and cap. Therefore, in order to achieve a correct seal, the tubing outside shape and diameter and the gripping sleeves must fit together exactly and the inside diameter of the fitting body must rather exactly admit the tubing with the gripping sleeves thereon, leaving little clearance space in which the gripping sleeves might move radially outward to loosen their grip on the tubing. If the device is disassembled, care must be taken with the gripping sleeves, which simply fall off the tubing when not disposed inside the fitting body. The end washer in the fitting body is also prone to fall out.

A similar arrangement having a sleeve that engages in only one corrugation is disclosed in U.S. Pat. No. 6,036,237—Sweeney. According to Sweeney, a ridge in the sleeve engages the tubing at the valley adjacent to the last outward corrugation ridge at a cut end of the tubing. The relative positions of the tubing, fitting body, sleeve and cap nut are such that the last corrugation, and only the last corrugation, is collapsed pressing and flattening the last corrugation of the tubing against a protruding nose of the fitting body, with axial advance of the cap nut and the sleeve during tightening down. The Sweeney operation, when all goes as intended, achieves a seal, using the resilient compression of the last corrugation as a deformable sealing element. The fitting relies on correct assembly and accuracy in positioning of the parts.

Some other similar arrangements have been attempted with limited success, for example as in U.S. Pat. No. 5,201,554, where the tubing is not axially compressed and one or more O-rings and retainers seal between the tubing and the inside of a cup shaped fitting. Another example is shown in U.S. Pat. No. 5,632,512. These sealing arrangements are based on providing a structure that retains the extreme end of the tubing axially in a sleeve shaped cup, and seals between the tubing and the cup using a resilient seal such as an O-ring that is spaced back from the axial end. Inasmuch as flexing could cause the tubing to bear against one side and gap at the other, such devices can have a further retainer at the open end of the cup to fix the position of the tubing there.

In order to achieve a good seal with a mechanical sealing arrangement such as in U.S. Pat. No. 4,630,850, it is necessary to position the parts accurately when commencing assembly, so that upon completion of assembly in the nominal way, the necessary positions, displacements, deformations and internal sealing pressures have been provided. This is not always a sure thing, particularly when there are a number of loose parts to put together.

It would be advantageous if a good seal could be provided in a structure of this general type, without the need a large number of parts or for parts that need to be very precisely shaped in order to function as intended. Generally, in addition to reducing the number of parts, it would be advantageous to improve on known fittings for corrugated tubing by reducing reliance on precise shapes and nominal positions, deformations and pressures, and generally to simplify the assembly of a fitting or similar tube termination. It would also be advantageous if fittings could be made less demanding of precision without detracting from the durability and dependability of the seal.

### SUMMARY OF THE INVENTION

It is an object of the invention to provide an improved structure for coupling an end of a corrugated tube to a receptacle fitting therefor, which may be an adapter for engaging with another sort of fitting, an attachment to a machine or the like, or any other sort of pipe coupling.

It is also an object to simplify the structure of such a fitting by reducing the number of parts that must be assembled, preferably even eliminating any requirement for assembly of parts apart from placing the fitting on a cut end of tubing, so as to bottom out the tubing in an opening of the fitting, and tightening the fitting to achieve a durable seal.

These and other objects are accomplished by a joint or coupling for corrugated tubing for sealing attachment to a free end of the tubing. A fitting body has an axial abutment shoulder disposed radially around a through-bore for sealing with the free end of the tubing, which is compressed against the shoulder for sealing. The fitting body has a cylindrical opening for the free end of the tubing, which can be infernally threaded and has with a decreasing inside diameter along a conical sloping surface, i.e., becoming narrower proceeding axially toward the shoulder. A clamping member is threaded onto the fitting body and has an axial face oriented toward the conical sloping surface. Turning the threaded clamping member axially moves the axial face toward or away from the conical sloping surface. A deformable split ring, with an annular part and a circumferential gap, is provided to engage in one of the corrugations of the tubing for sealingly compressing the free end of the tubing against the abutment shoulder. The split ring has a starting dimension at which an outer diameter of the split ring fits within the relatively wider inside diameter of the conical sloping surface and can engage in a valley of the tubing. Axial advance of the clamping member likewise causes the axial advance of the split ring along the conical sloping surface. The split ring is thus cinched radially inwardly around the tubing at the valley, and axially bears against the tubing, sealingly compressing the free end of the tubing against the axial abutment shoulder by compressing the ridges and valleys between the split ring and the free end. A guide sleeve fits within the tubing at the free end, the guide sleeve opposing the split ring and bearing radially outwardly from within the tubing. Preferably the guide sleeve is an integral extension of the fitting body and serves positively to center the tubing. Alternatively the guide sleeve can be a separate part that fits inside the tubing or over which the end of the tubing is passed in an assembly step.

### BRIEF DESCRIPTION OF THE DRAWINGS

There are shown in the drawings certain embodiments of the invention as presently preferred. It should be understood that the invention is not limited to the precise arrangements and instrumentalities shown in the drawings, wherein the same reference numbers refer to the same parts in the respective views, and wherein:

FIG. 1 is a perspective view showing the fitting assembly of the invention during a beginning assembly step, with one quadrant shown cut away for purposes of illustration.

FIG. 2 is a perspective view of a split ring retainer used in the fitting assembly as shown in FIG. 1.

FIG. 3 is a perspective view corresponding to FIG. 1, showing the fitting after assembly is complete.

FIG. 4 is a side elevation showing the fitting parts.

FIG. 5 is a section view corresponding to FIG. 4, showing initial steps in assembling the fitting to the end of a length of tubing.

FIG. 6 is a detail view of the area shown by the circle in FIG. 5.

### DETAILED DESCRIPTION OF THE PREFERRED EMBODIMENTS

The invention is described with reference to the accompanying drawings, wherein the same reference numbers identify the same elements throughout the views. In this description, terms that denote a particular orientation or relationship of the parts generally refer to the orientation or relationship shown in the drawing(s) being discussed, and such terms do not necessarily exclude other orientations or relationships of the type discussed.

Referring to FIG. 1, a fitting 20 having a passageway 22 is to be sealingly attached to an end of a length of tubing 24, such that the passageway 22 and the lumen or internal passage 26 of the tubing 24 are joined together without leaks or similar communication with the outside. This is accomplished according to the invention using a clamping nut 32 and a fitting body 34 to form a sealing engagement with the tubing 24 adjacent to a sealing end 36 of the tubing 24. According to an inventive aspect, the clamping nut 32 and fitting body 34 cooperate to engage the tubing 24 using a deformable split ring 42.

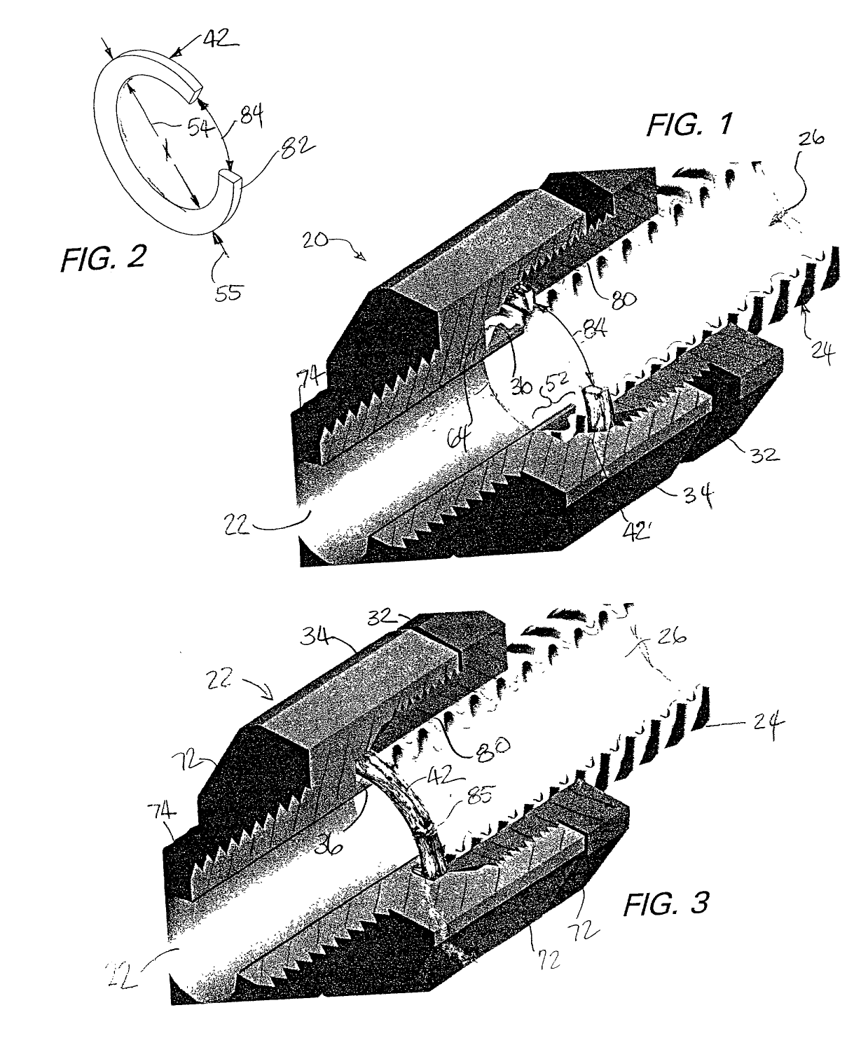

To tighten the fitting 20 on the tube 24, the clamping nut 32 needs to be positioned over the end of the tubing, leaving a short protruding length 52 of tubing 24, with a deformable split ring 42 being in position to be advanced along the tubing toward the fitting body as shown in FIG. 2. However it is an aspect of the invention that it is not necessary to disassemble the fitting parts and to re-assemble them on the tube end. Instead, the split ring 42 is initially captive between the clamping nut 32 and the fitting body 34. The cut end of the corrugated tubing 24, preferably with any outside insulation removed, is inserted through the clamping nut 32, and abuts endwise against the fitting body 34. In this position the tubing 24 also extends through the split ring 42.

The split ring 42 has an internal diameter 54 that admits the end of the tubing 24. The split ring 42 can be placed on the tubing preliminarily, at a predetermined number of corrugations from the cut end of the tubing 24, for example on the proximal side of the second annular ridge 56 (i.e., in the first valley 58 between ridges 56 adjacent to the extreme cut end 36). Preferably, however, and as shown in FIG. 1, by inserting the tube so as to bottom out against the fitting body in the pre-assembly comprising the fitting body, the split ring and the clamping nut, the split ring is repeatably and correctly positioned at the nominal location needed.

With the clamping nut 32 just snugly threaded onto the fitting body 34, the split ring rests initially against the axial end or nose of the clamping nut and at the entering or wider part of a conical surface 66. See also FIGS. 5 and 6. The split ring has a gap 84 initially, and thus has a relatively large inside diameter. This diameter is sufficient to admit the tube. As the clamping nut 32 is tightened on the fitting body, that is as the clamping nut 32 is threaded forwardly into the fitting body 34 to the position shown in FIG. 3, the split ring 42 is carried axially forward toward a sealing abutment 64 of the fitting body 32 to clamp and seal the end 36 of the tubing to the fitting body 32. This carries the split ring axially forward along the conical surface 66 toward the smaller diameter part of the conical surface, and forces the spit ring to deform radially inwardly toward the tube 24. The conical surface and the split ring are sized such that as the split ring is carried axially forward, the spilt ring compresses down into a valley between adjacent corrugation ridges on the tubing 24. Thus the split ring engages and supports the tubing 24 as a point that is a short longitudinal distance back from the extreme end, and carried the end forward to be sealed with the fitting body.

The fitting body 34 has a generally cylindrical hollow inside shape 62 , and is internally threaded to receive the clamping nut or member 32, which is externally threaded. The fitting body 34 has a blind axial face 64 that is to seal with the end 36 of the tubing 24. The blind axial sealing face 64 generally surrounds the passageway 22 through the fitting body 34. A conical surface 66 is provided within the fitting body 34, defining a decreasing diameter proceeding axially toward the blind sealing face 64. This conical surface 66 is dimensioned to admit the outside diameter of the split ring 42. As the clamping nut 32 is threaded into the fitting body 34 and advances toward the blind axial sealing face 64, the clamping nut 32 pushes the split ring 42 axially along the conical surface 66. The conical narrowing compresses the spit ring 42, causing the split ring 42 to cinch radially inwardly against the tubing 24 at approximately two corrugation ridges from the end. More particularly, split ring 42 is compressed circumferentially and radially, and settles into a valley 58 between annular ridges 56 on tubing 24. At that position, the split ring 42 is cinched into a position at which axial force on the split ring 42 is coupled directly into axial force against the proximal side of the adjacent one of the annular ridges 56. In this manner, as shown in FIG. 3, the tubing 24 is forced by axial advance of the clamping nut 32, against the blind axial sealing face 64 inside the fitting body 34. The endmost ridges and valleys of the tubing 24, namely those on the distal side of the split ring 42, are compressed, resiliently deformed and forced by the clamping nut 32 against the blind axial sealing face 64. This achieves a good seal between the tubing 24 and the fitting body 34 as well as a durable and strong mechanical attachment. The point of sealing is also longitudinally spaced by several corrugation ridges and valleys (five or six in the example shown) from the point at which the tubing is unsupported. Thus the seal is protected from flexing due to forces exerted on the unsupported portion of the tubing.

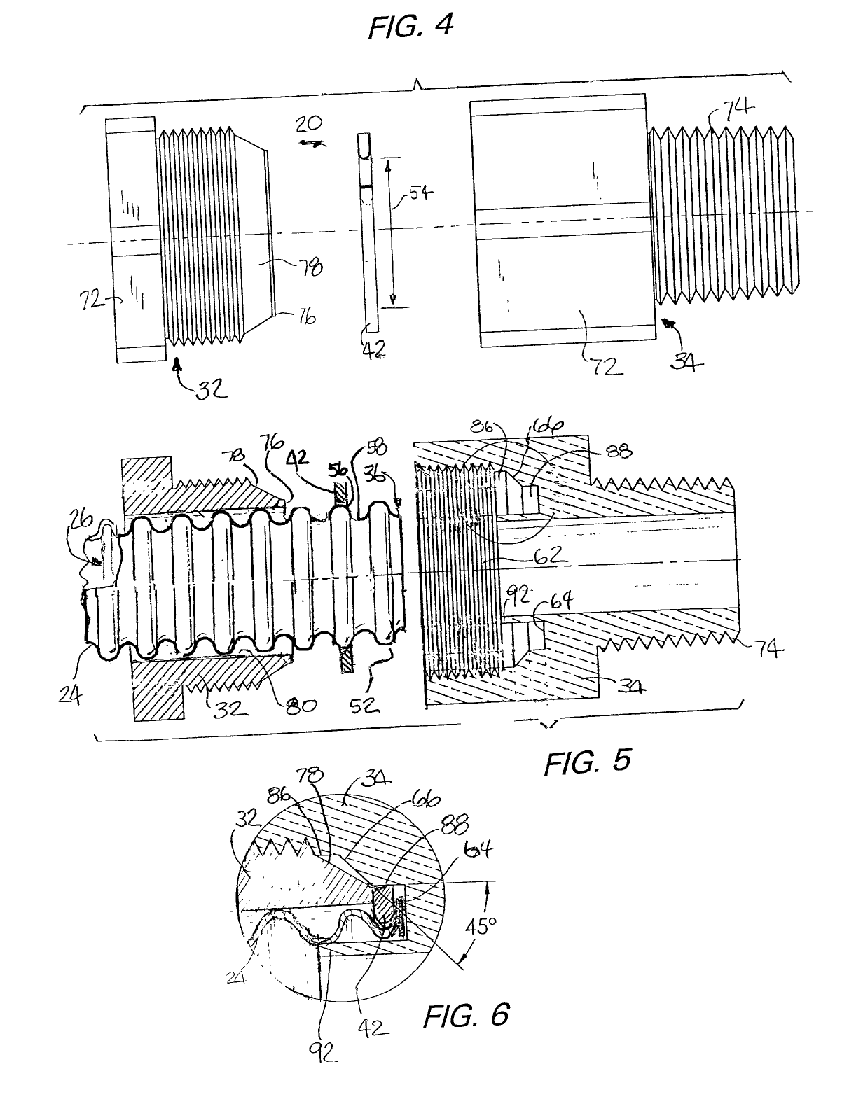

FIG. 4 shows the parts needed for coupling 20 in elevation view. It is an advantageous aspect of the invention that only three separable parts are required, plus the tubing to be terminated or coupled. The clamping nut 32 can be provided as threaded loosely into the fitting body 34 with the split ring 42 captive. The clamping nut 32 and the fitting body 34 can have hexagonal flats 72 for receiving wrenches, the nut and body having the same or different spans, for tightening the clamping nut 32 into the fitting body 34 when making a sealing connection.

In the embodiment shown, the fitting body 34 has an externally threaded end 74 opposite from the end that receives the corrugated tube 24. This external thread is shown merely for purposes of illustration, whereby the fitting body 34 can be sealingly attached to any of various further structures defining a flowpath to be coupled to tubing 24. The fitting body 34 could have a different sort of attachment structure. The attachment structure could be internal or external. The fitting body 34 also could be an integral part of a fixture and in that case may not need an additional attachment structure.

The invention is illustrated in connection with an exemplary application in which the corrugated tubing 24 can be flexible stainless steel tubing for carrying natural gas, for example for coupling a gas burning appliance to a fixed gas pipe (not shown). The appliance and the fixed gas pipe typically have threaded fittings, such as tapered thread fittings, that attach to fitting bodies on either end of a flexible hollow tube. The tube can be all metal, or preferably can have a plastic sheath (not shown). The plastic sheath can be stripped back and a fluid tight pressure seal made between the tubing and fitting bodies as shown, at the respective ends of the tubing, where fluid tight threaded couplings are made to the appliance and the gas pipe.

The fitting body 34 and the clamping nut 32 can be made, for example, of brass. Preferably, the split ring 42 is a malleable material and in a preferred embodiment the split ring is made of brass. The split ring 42 need not have spring-return aspects, although it is possible to employ a spring-like material (e.g., spring steel) if it is desirable to assemble and disassemble the coupling frequently.

Brass is preferred as the material for the fitting body 34, clamping nut 32 and split ring 42, particularly if the tubing 24 is to carry natural gas. Other materials are likewise possible, such as aluminum, or even rubber or plastic, and may be preferred depending on the type of gas or liquid being carried, the pressure differential with the outside, and other factors that should be readily apparent.

FIGS. 4 and 5 respectively show an exploded view and an exploded perspective view. Although the fitting is preferably supplied with the clamping nut threaded to the fitting body and the split ring captive, it would also be possible to assemble the parts from separate pieces. In that case, FIG. 5 would represent preliminary assembly steps proceeding to the point shown in FIG. 1. FIG. 6 shows in detail the seal area upon completion of assembly and tightening, as also shown in FIG. 3.

The invention concerns a coupling 20 for sealing attachment to a free end 36 of corrugated tubing 24 having successive ridges 56 and valleys 58 along a longitudinal axis of the tubing 24 adjacent to the free end of the tubing. The coupling 20 has a fitting body 34 having a generally axial through bore 22 to be coupled in communication with the tubing 24, and an axial abutment shoulder or blind sealing face 64, disposed radially around the through-bore 22 for sealing with the free end 36.

The fitting body 34 has a substantially cylindrical opening 62 for the free end of the tubing. However, the cylindrical opening 62 is axially or longitudinally adjacent to a decreasing inside diameter end, along a conical sloping surface 66. The conical sloping surface 66 is progressively radially narrower proceeding axially (or longitudinally) toward the inner axial shoulder or blind sealing face 64.

The fitting body 34 receives a clamping member 32, also referred to as the clamping nut. The clamping member 32 can be internally or externally attached to the fitting body 34, so long as the clamping member 32 has or moves a contacting nose portion 76 that can be advanced axially and is oriented toward the conical sloping surface 66 of the fitting body 34. In the embodiment shown, the clamping member or clamping nut 32 has a part with wrench flats, integral with an externally threaded cylindrical part that threads into the internal threads of the fitting body 34. The clamping nut 32 has a taper78 at the axial end to a flat nose 76 facing towards the sealing face 64 of the fitting body 34. The clamping member or nut 32 is threadably attachable to the fitting body 34 and advancing the thread moves nose 76 axially toward and beyond the conical sloping surface 66 toward the sealing face 64 of the fitting body 34. The nose 76 carries the split ring 42 toward the blind axial sealing face 64 of the fitting body 34 until the last protruding corrugations are compressed between the split ring 42 and the sealing face 64, where a fluid tight seal is made between the coupling 20 and the end 36 of the tubing 24.

The inside of the clamping nut 32 has a smoothly cylindrical bore 80, and has a diameter that is just slightly larger than the outside diameter of the annular ridges 56 of the tubing 24 to provide just minimal sliding clearance. The smoothness of the bore 80 and the clearance provided are such that the tubing 24 and the clamping nut 42 can be moved freely over or through one another. However as a result, the clamping nut 32 lacks sufficient structure of itself, to seal with the tubing or to engage a longitudinal point along the tubing as would be needed to urge the cut tubing end 36 endwise against the blind axial sealing face 64 of the fitting body 34.

This is the purpose of the deformable split ring. The deformable split ring 42 defines an annular part 82 and has a circumferential gap 84 (see FIG. 2). The split ring 42 has a starting dimension at which its inner diameter 54 is wide enough to pass over the tubing 24, and its outer diameter 55 permits the split ring 42 to be inserted into the hollow inside of the fitting body 34, at least into the relatively wider inside diameter 86 leading into the conical sloping surface 66. These dimensions are within the tolerance necessary to put the split ring 42 onto the tubing 24 and into the fitting body 34, but it is possible and perhaps advantageous that some resistance is encountered which the assembler must overcome manually by forcibly urging the split ring 42 over the ridges 56 of the tubing or to fit into the leading part 86 of the conical constriction of the surface 66 leading up to the sealing face 64. The split ring 64 is thus dimensioned to be placed on the tubing 24 and in the fitting 34, which according to the invention are to be done at the same time. Manually forcing a slightly small split ring 42 over the annular ridges 56 at the end of the tubing 24 also may be advantageous because it tends to capture the split ring 42 on the tube 24.

In a preferred arrangement, the split ring fits snugly in or to at least one of the tubing and the fitting body. The split ring can be placed in the fitting body and held at the wide diameter end of the conical surface 66 by radial contact with the fitting body and by axial capture between the fitting body and the clamping nut. The tubing fits snugly through the clamping nut and snugly through the split ring, whereby the respective parts are snug when assembled. This advantageously provides at least a temporary but un-sealed attachment between the fitting body 34 and the tubing 24. Although some tightness of this sort is preferred, it is also possible that the relative dimensions to could be such that the parts slide freely over and through one another, particularly since the fitting body, split ring and clamping nut are pre-assembled and there are no loose parts other than the fitting and the tubing, respectively. Assembling these parts requires only that the tubing be inserted to through the clamping nut to bottom out against the fitting body. The places the split ring in position to engage axially behind the second last corrugation ridge. The clamping nut is tightened using a wrench, whereupon the split ring is cinched inwardly against the corrugated tubing and presses the corrugated tubing along axially. The tightening can be continued until the threaded parts jam because the split ring has been advanced as far as possible. There is no requirement to exert a particular torque, and instead the thread is simply run to its extreme of travel.

The split ring 42 as shown in FIG. 2, defines a portion of a full circumference. The gap 84 in the split ring is advantageously 60 to 70 degrees, and in the exemplary embodiment shown the gap is 65 degrees. Comparing FIGS. 1 and 3, tightening the fitting causes the 65 degree gap in FIG. 1 to close completely at a point of abutment 85 in FIG. 3.

In the embodiment shown, the circumference and the inside diameter of split ring 42 are reduced to about 82% of their original dimensions by cinching or compressing the split ring 42 to the maximum limit defined by the point 85 at which the circumferential ends of the split ring come into abutment. Whereas the split ring 42 initially is just large enough to be placed over the radially protruding annular ridges 56 of the tubing 24, cinching or compressing the split ring reduces its inside diameter and brings the split ring down into a position at which the split ring nestles in and engages the walls of a valley 58 of the tubing 24, between ridges 56 that can then be engaged by the split ring 42 in an axial or longitudinal direction.

The clamping member (clamping nut) 32 and the split ring 42 are preassembled with the fitting body. The tubing 24 is inserted as shown in FIG. 5. The split ring 42 is thus located toward the free or distal end 36 of the tubing 24 from the clamping nut 32, which is on the proximal side. The split ring 42 is prepositioned in the fitting body, for example, to be located at the second ridge 58 between annular valleys 56 as shown, when the ring 42 engages the tubing. Upon subsequent tightening of the clamping nut 32 with the fitting body 34 and resulting axial advance, the axial end or nose 76 of the clamping nut 32 bears against the split ring 42. The split ring 42 is forced to move axially up to the end of the hollow in the fitting body 34, where the split ring encounters the conical sloping surface 66 that forces the split ring to cinch down. With further axial advance of the split ring 42 by threading of clamping nut 32 and axial/longitudinal advance of nose 76, the outside diameter of the split ring 42 bears against the progressively narrower conical surface 66. This forces the annular split ring 42 radially inwardly with circumferential shortening and closing of gap 84. The split ring 42 is cinched around the tubing 24 at the valley 58 and thereby securely engages the tubing 24 at a fixed longitudinal point, namely in a valley 58 between two adjacent annular ridges 56.

The geometry of the arrangement controls the specific point at which the split ring engages the tubing. In the embodiment shown, the split ring engages in the last valley between corrugation ridges from a starting position at which the sixth corrugation ridge is just at the opening of the clamping nut and the tubing 24 has bottomed out, through the split ring and against the axial end face of the fitting body 34. The conical surface 66 is at 45 degrees, so that as the split ring is advanced axially through the distance of about one corrugation pitch (one ridge and one valley), the split ring is cinched tightly onto the tubing and the tubing is advanced to a point at which the protruding corrugation ridges have been flattened against the fitting body into sealing metal to metal contact.

As shown in FIG. 5, there are larger and smaller short smooth cylindrical portions 86, 88, respectively, on the inner surface of the fitting body 34 for a short distance on each axial side of the conical surface 66. As the clamping member/nut 32 forces the split ring 42 into progressively more tightly cinched and axially advanced positions, the split ring 42 eventually reaches the smaller diameter cylindrical section, and further advance of the clamping member moves the split ring 42 exclusively axially. Tightening or threading of the clamping member/nut 32 into the fitting body 34 when the clamping nut 32 is near its axial limit, compresses the free end of the tubing, namely the ridges and valleys 56, 58 between the split ring 42 and the ultimate cut end 36 of the tubing 24, against the axial abutment shoulder 64. The last corrugations of the tubing are compressed and pressed against the axial abutment shoulder 64, achieving a fluid tight seal.

FIG. 6 is a detail view showing the seal area at the position shown by the circle in FIG. 5. The fitting body 34 in the exemplary arrangement shown, comprises a guide sleeve 92 dimensioned to fit within the lumen of the corrugated tubing 24 at the free end 36. This sleeve 92 tends to ensure that the corrugated tubing 24 at the free end 36. This sleeve 92 tends to ensure that the tubing 24 is centered relative to the axis of the guide sleeve 92 and confines the tubing 24 to the annular cylindrical space 88 between the guide sleeve 92 and the conical surface 66, and ultimately between the sleeve 92 and the smallerdiameter cylindrical surface 88 immediately adjacent to the blind axial sealing end face 64. The guide sleeve 92 also opposes the split ring 42 in that the guide sleeve 92 supports the tubing 24 radially outwardly from within, against the split ring 42 bearing radially inwardly on the outer surface due to pressure from the conical surface 66.

In this arrangement, the guide sleeve 92 comprises an integral extension of the fitting body 34. It is possible to employ a guide sleeve 92 that forms a loose tube. This maintains the inside dimensions of the tubing, but does not ensure that the tubing 24 and the seal at its end remain accurately concentric. However, by making the sleeve 92 integral, there are only three separate parts involved, unlike many other tube fitting couplings which required more attention and dexterity to assemble and to obtain a proper seal. Unlike many other arrangements, there is no assembly of parts required of the user because the clamping nut, split ring and fitting body are supplied as a unit and need only be placed over the end of a tube and tightened.

FIGS. 4 and 5 show that the split ring 42 has a rounded surface complementary with one of the valleys, facing radially inwardly. The split ring has a flat cylindrical surface on the radially outward facing side, and a planar flat face oriented toward the axial abutment or blind sealing surface 64.

The fitting body 34 is internally threaded leading up to the conical sloping surface 66. The clamping member 32 is externally threaded for advancing along the fitting body 34 to compress the split ring 42 by axially advancing the split ring 42 along the conical sloping surface 66. As shown in FIG. 6, the conical sloping surface 66 is inclined at an angle that is not as acute as the conical angle 78 of the clamping member 32 proceeding up to its axial facing nose 76 that bears against the split ring 42. The angle of the conical sloping surface of the fitting body is about 45 degrees in the example shown. The conical angle of the clamping member is about 30 degrees. As shown in FIG. 6, the conical faces 66, 78 of the fitting body and the clamping member thus do not meet at face-to-face surface contact and instead, the more tapered and radially inner nose 76 and conical part 78 of the clamping member 32 meet the fitting body 34 at the cusp between the conical sloping surface 66 and the radially inner cylindrical portion 88 of the fitting body 34. A cylindrical/annular end on the clamping member 32 prevents interference. Potential overtightening of the clamping member 32 causes the nose 76 of the clamping member 32 to pass the cusp and to further compress the endmost annular ridges forming the seal, rather than to jam tightly. As a result, it is not overly difficult to unthread the coupling if it becomes necessary to make a new fitting termination.

In the embodiment shown and described, the corrugated tubing 24 is annular rather than helical. Thus the ridges 56 and valleys 58 are annular and a smooth circular end results where the free end of the tubing 24 is cut perpendicular to the tube axis. This sort of tubing lends itself to the sealing arrangement shown, wherein the free end of the tubing seals directly against the axial abutment surface by compression from the split ring.

The invention is described with reference to a fitting that attaches the tubing to an unspecified other item that engages the externally threaded part of the fitting body. The invention generally is applicable to any sort or tubing joint, and is not limited to a fitting body of this type. Provided there is a length of corrugated tubing having successive ridges and valleys along a longitudinal axis of the tubing, the coupling of the invention and the tube joint it achieves can be provided at one or both ends of the tubing. It can attach to a fitting body that is an integral element of some further apparatus or vessel. It can comprise a double ended fitting body with the same sorts of couplings in two or more directions, etc.

The invention is capable of application to a range of embodiments, and reference made to the appended claims rather than the foregoing discussion of preferred arrangements, to determine the scope of the invention in which exclusive rights are claimed.

What is claimed is:

1. A coupling for sealing attachment to a free end of corrugated tubing having successive ridges and valleys along a longitudinal axis of the tubing adjacent to a free end of the tubing, the coupling comprising:
a fitting body having a generally axial through bore to be coupled in communication with the tubing, and an axial abutment shoulder disposed radially around the through-bore for sealing with the free end, the fitting body having a substantially cylindrical opening for the free end of the tubing, with a decreasing inside diameter along a conical sloping surface, the conical sloping surface becoming narrower proceeding axially toward the inner axial shoulder;
a clamping member having an axial face oriented toward the conical sloping surface, the clamping member being attachable to the fitting body and movable axially for advancing the axial face toward the conical sloping surface;
a deformable split ring defining an annular part and a circumferential gap, the split ring having a starting dimension at which an outer diameter of the split ring fits within the relatively wider inside diameter of the conical sloping surface and can engage in a valley of the tubing;
wherein axial advance of the clamping member causes the axial face to bear against the split ring, thereby moving the split ring along the conical sloping surface, so as to cinch the split ring radially inwardly around the tubing at the valley, and to sealingly compress the free end of the tubing against the axial abutment shoulder.

2. The coupling of claim 1, further comprising a guide sleeve dimensioned to fit within the tubing at the free end, the guide sleeve opposing the split ring and bearing radially outwardly from within the tubing.

3. The coupling of claim 2, wherein the guide sleeve comprises an integral extension of the fitting body.

4. The coupling of claim 2, wherein the guide sleeve comprises a length of tubing that is separate from the fitting body.

5. The coupling of claim 1, wherein the fitting body, the clamping member and the split ring are preassembled and the fitting body, clamping member and split ring are dimensioned to engage against the tubing upon insertion of the tubing in the clamping member and tightening of the clamping member on the fitting body.

6. The coupling of claim 1, wherein the split ring has a rounded surface complementary with one of the valleys, facing radially inwardly, and a flat radial surface facing the axial abutment surface.

7. The coupling of claim 1, wherein the fitting body is internally threaded leading up to the conical sloping surface and the clamping member is externally threaded for advancing along the fitting body to compress the split ring by axially advancing the split ring along the conical sloping surface.

8. The coupling of claim 1, wherein the ridges and valleys are annular and wherein the free end of the tubing seals directly against the axial abutment surface by compression from the split ring.

9. A tubing joint, comprising:
a length of corrugated tubing having successive ridges and valleys along a longitudinal axis of the tubing adjacent to a free end of the tubing; a fitting body having a generally axial through bore to be coupled in communication with the tubing, and an axial abutment shoulder disposed radially around the through-bore for sealing with the free end, the fitting body having a substantially cylindrical opening for the free end of the tubing, with a decreasing inside diameter along a conical sloping surface, the conical sloping surface becoming narrower proceeding axially toward the inner axial shoulder;
a clamping member having an axial face oriented toward the conical sloping surface, the clamping member being attachable to the fitting body and movable axially for advancing the axial face toward the conical sloping surface;
a deformable split ring defining an annular part and a circumferential gap, the split ring having a starting dimension at which an outer diameter of the split ring fits within the relatively wider inside diameter of the conical sloping surface and can engage in a valley of the tubing;
wherein axial advance of the clamping member causes the axial face to bear against the split ring, thereby moving the split ring along the conical sloping surface, so as to cinch the split ring radially inwardly around the tubing at the valley, and to sealingly compress the free end of the tubing against the axial abutment shoulder.

10. The joint of claim 9, further comprising a guide sleeve dimensioned to fit within the tubing at the free end, the guide sleeve opposing the split ring and bearing radially outwardly from within the tubing.

11. The joint of claim 10, wherein the guide sleeve comprises an integral extension of the fitting body.

12. The joint of claim 10, wherein the guide sleeve comprises a length of tubing separate from the fitting body.

13. The joint of claim 9, wherein the split ring has a rounded surface complementary with one of the valleys, facing radially inwardly, and a flat radial surface facing the axial abutment surface.

14. The joint of claim 9, wherein the fitting body is internally threaded leading up to the conical sloping surface and the clamping member is externally threaded for advancing along the fitting body to compress the split ring by axially advancing the split ring along the conical sloping surface.

15. The joint of claim 9, wherein the ridges and valleys are annular and wherein the free end of the tubing seals directly against the axial abutment surface by compression from the split ring.
